(19) United States
(12) Patent Application Publication
(10) Pub. No.: US 2011/0078192 A1
(43) Pub. Date: Mar. 31, 2011

(54) INFERRING LEXICAL ANSWER TYPES OF QUESTIONS FROM CONTEXT

(75) Inventor: James W. Murdock, IV, Hawthorne, NY (US)

(73) Assignee: INTERNATIONAL BUSINESS MACHINES CORPORATION, Armonk, NY (US)

(21) Appl. No.: 12/570,575

(22) Filed: Sep. 30, 2009

(51) Int. Cl. G06F 17/30

(52) U.S. Cl. 707/780; 707/E17.017

(57) ABSTRACT

A method, system and computer program product are disclosed for searching for an inferred lexical answer type from the context of a question. One embodiment comprises determining from a question an original lexical answer type (LAT), extracting the context in which said original LAT occurs within the question, and identifying a set of context fragments from said context. This embodiment further comprises using the set of context fragments to search through a defined database to produce a search result including a plurality of text strings having a specified relationship with said context fragments, and processing said search result to search for one or more inferred LAT of the question. In one embodiment, the processing includes extracting a plurality of LATs from the text strings in the search result, and selecting one or more of the extracted LATs as the one or more inferred LAT of the question.

### CROSS-REFERENCE TO RELATED APPLICATIONS

The present application related to co-pending U.S. patent application Ser. No. 12/152,411, for “System And Method For Providing Answers To Questions,” filed May 14, 2008, and to U.S. patent application Ser. No. 12/126,642, for “System and Method For Providing Question And Answers With Deferred Type Evaluation,” filed May 23, 2008. The entire contents and disclosures of said U.S. patent application Ser. No. 12/152,411 and U.S. patent application Ser. No. 12/126,642 are incorporated by reference herein in their entireties as if fully set forth herein.

### BACKGROUND OF THE INVENTION

1. Field of the Invention

The present invention generally relates to information retrieval, and more specifically, the invention relates to finding answers to natural language queries in a natural language database.

2. Background Art

The field of retrieval of information from a natural language text database has in the past been focused on the retrieval of documents matching one or more key words given in a user query. As an example, most conventional search engines on the Internet use a Boolean search to match key words given by the user. Such key words are considered to be indicative of topics, and the task of standard information retrieval system has been seen as matching a user topic with document topics. Due to the immense size of the text database to be searched in information retrieval systems today, such as the entire text database available on the Internet, this type of search for information has become a very blunt tool for information retrieval. A search most likely results in an unwieldy number of documents. Thus, it takes a lot of effort from the user to find the most relevant documents among the documents retrieved, and then to find the desired information in the relevant documents. Furthermore, due to the ambiguity of words and the way they are used in a text, many of the documents retrieved are irrelevant. This makes it even more difficult for the user to find the information needed.

Generally, Question Answering (QA) is another type of information retrieval. Given a collection of documents (such as the World Wide Web or a local collection), a QA system should be able to retrieve answers to questions posed in natural language. QA is regarded as requiring more complex natural language processing (NLP) techniques than other types of information retrieval such as document retrieval, and it is sometimes regarded as the next step beyond search engines.

One major unsolved problem in QA is the lack of a computer program capable of answering factual questions based on information included in a collection of documents (of all kinds, structured and unstructured). Such questions can range from general such as “what are the risks of vitamin K deficiency” to narrow such as “when and where was George Washington's father born”.

The challenge is to understand the query, to find appropriate documents that might contain the answer, and to extract the correct answer to be delivered to the user. Currently, understanding the query is an open problem because computers do not have the human ability to understand natural language nor do they have the common sense to choose from many possible interpretations that current (very elementary) natural language understanding systems can produce.

The above-mentioned U.S. patent application Ser. No. 12/126,642 describes a system and method in which answers are generated for questions by comparing the lexical types that are explicitly requested by the question to the lexical types associated with each candidate answer obtained from a search. U.S. patent application Ser. No. 12/126,642 indicates that the lexical answer type (LAT) and any modifiers to it are obtained from the original question. There are some situations, however, where no useful LAT is explicit in the clue.

### SUMMARY OF THE INVENTION

Embodiments of the invention provide a method, system and computer program product for searching for an inferred a lexical answer type from the context of a question. One embodiment comprises receiving a question, determining from the question an original lexical answer type (LAT), extracting the context in which said original LAT occurs within the question, and identifying a set of context fragments from said context. This embodiment further comprises using the set of context fragments in a given procedure for searching through a defined database to produce a search result including a plurality of text strings having a specified relationship with said context fragments, and processing said search result to search for one or more inferred LAT of the question.

In one embodiment, the processing includes extracting a plurality of LATs from the text strings in the search result, and selecting one or more of the extracted LATs. The selecting extracted LATs may, for example, be done by ranking said extracted LATs according to a given criteria; and selecting said extracted LATs on the basis of said ranking. This ranking may be based on the frequency with which each of the extracted LATs occurs in said plurality of text strings.

In one embodiment, abstract versions of the context fragments are produced, and the context fragments and the abstract versions of the context fragments are input to a search component. The search engine searches through the defined database for text strings that match either the context fragments or the abstract versions of the context fragments according to defined criteria.

For some questions, some plausible lexical types of a question are implicit in the text of the question. Consider the example “What flew from New York to Paris in May of 1927?” There is no explicit LAT in the question. However some potential LATs can be inferred by trying to consider things that fly: airplanes, birds, etc. This information can be derived from a large text corpus by, for example, searching for “fly,” determining what strings precede it, and counting the occurrences of different terms such as “airplane”, “bird”, etc. Confidence values can be produced for the entries in this list using the frequency of occurrences. An n-gram corpus is a particularly useful resource for enabling such a search, because frequency data for snippets of text are precompiled in that resource. A keyword search index is an alternative component that satisfies this requirement (but requires that the invoking process count all of the occurrences instead of combining counts that are precomputed).

The list can be further refined by examining larger quantities of context. For example, a search can be conducted to try to find things that fly from New York, or things that fly to Paris, things that fly in May of 1927, etc. A type hierarchy can also be used to identify more abstract variations of the context, e.g., things that fly from specified cities, things that fly on specified dates. By combining statistics from different amounts of context, better confidence values can potentially be produced. These confidence values can be used by an end-to-end QA system to produce more informative scores.

The inferred LATs and their confidence values can be used by the remaining portions of a deferred type evaluation process, such as disclosed in U.S. patent application Ser. No. 12/126,642, to identify Candidate Answers to the question that are of the appropriate type, so that those Candidate Answers can be preferred over Candidate Answers that are not of the appropriate type.

### BRIEF DESCRIPTION OF THE DRAWINGS

FIG. 1 shows a logical architecture and Question Answering method that may be used to implement embodiments of the invention.

FIG. 2 illustrates data and procedural elements of an embodiment of this invention.

FIG. 3 shows a more specific example of an embodiment of the present invention.

FIG. 4 is an example flow diagram for conducting Question Answering in which the present invention may be used.

FIG. 5 depicts a computing environment that may be used to practice this invention.

### DETAILED DESCRIPTION OF THE PREFERRED EMBODIMENTS

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction operation system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to .produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

As will be referred to herein, the word “question” and “query,” and their extensions, are used interchangeably and refer to the same concept, namely request for information. Such requests are typically expressed in an interrogative sentence, but they can also be expressed in other forms, for example as a declarative sentence providing a description of an entity of interest (where the request for the identification of the entity can be inferred from the context). “Structured information” (from “structured information sources”) refers to information whose intended meaning is unambiguous and explicitly represented in the structure or format of the data (e.g., a database table). “Unstructured information” (from “unstructured information sources”) refers to information whose intended meaning is only implied by its content (e.g., a natural language document). “Semi structured” data refers to data having some of the meaning explicitly represented in the format of the data, for example a portion of the document can be tagged as a “title.”

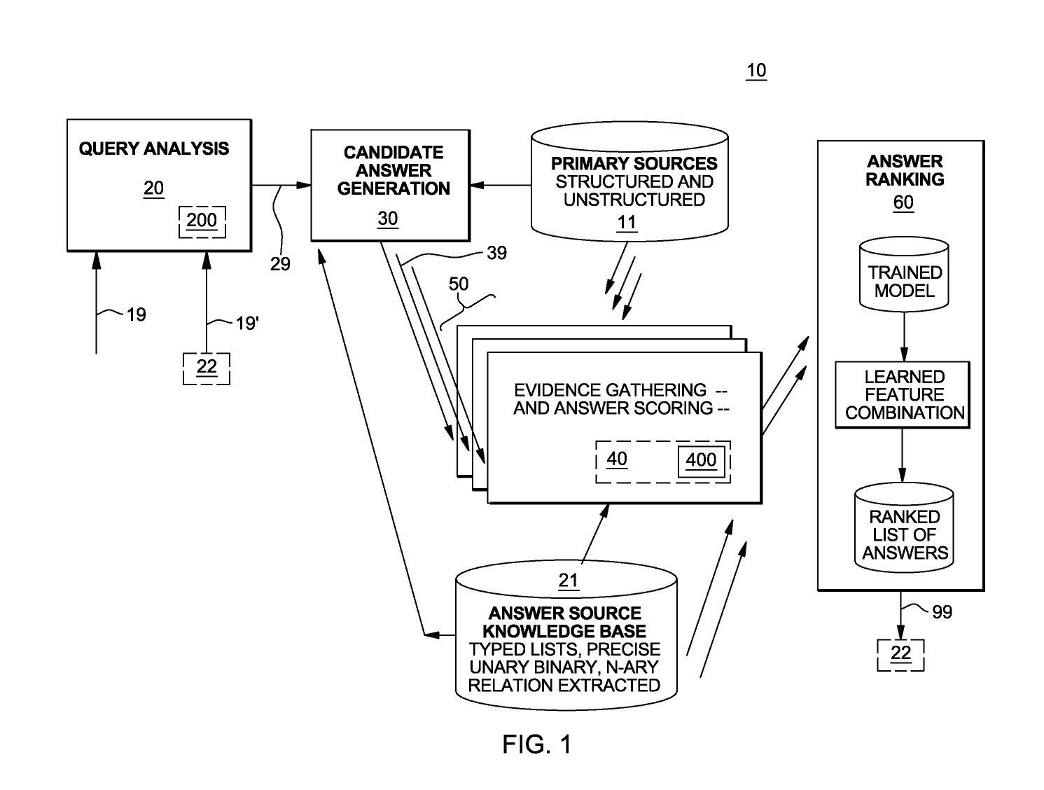

FIG. 1 shows a system diagram depicting a high-level logical architecture 10 and methodology for implementing Question Answering (QA). As shown in FIG. 1, architecture 10 includes a Query Analysis module 20 implementing functions for receiving and analyzing a user query or question. In one embodiment, a “user” refers to a person or persons interacting with the system, and the term “user query” refers to a query (and its context) 19 posed by the user. However, it is understood that other embodiments can be constructed, where the term “user” refers to a computer system 22 generating a query by mechanical means, and the term “user query” refers to such a mechanically generated query and context 19′. A candidate answer generation module 30 is provided to implement a search for candidate answers by traversing structured, semi structured and unstructured sources contained in a Primary Sources module 11 and in an Answer Source Knowledge Base module 21 that includes collections of relations and lists extracted from primary sources. All the sources of information can be locally stored or distributed over a network, including the Internet.

The Candidate Answer generation module 30 generates a plurality of output data structures having candidate answers based upon the analysis of retrieved data. In FIG. 1, an embodiment is depicted that includes an Evidence Gathering module 50 interfacing with Primary Sources 11 and Knowledge Base 21 for concurrently analyzing the evidence based on passages having candidate answers, and scoring each of the candidate answers, for example, as parallel processing operations. In one embodiment, the architecture may be employed utilizing the Common Analysis System (CAS) candidate answer structures. This processing is depicted in FIG. 1 where the Evidence Gathering module 50 comprises a Candidate Answer Scoring module 40 for analyzing a retrieved passage and scoring each of the candidate answers of a retrieved passage.

The Answer Source Knowledge Base 21 may comprise one or more databases of structured or semi-structured sources (pre-computed or otherwise) comprising collections of relations (e.g., Typed Lists). In an example implementation, the Answer Source knowledge base may comprise a database stored in a memory storage system, e.g., a hard drive. An Answer Ranking module 60 provides functionality for ranking candidate answers and determining a response 99 returned to a user via a user's computer display interface (not shown) or a computer system 22, where the response may be an answer, or an elaboration of a prior answer or a request for clarification in response to a question.

The architecture of FIG. 1 comprises a machine learning implementation, where the Answer Ranking module 60 includes a trained model component 70 produced using a machine learning techniques from prior data. The prior data may encode information on the features of candidate answers, the features of passages from which the candidate answers come, the scores given to the candidate answers by Candidate Answer Scoring modules 40, and whether the candidate answer was correct or not. Machine learning algorithms can be applied to the entire content of the CASs together with the information about correctness of the candidate answer. Such prior data is readily available, for instance, in technical services support functions, or in more general settings on the Internet, where many websites list questions with correct answers. The Trained model module encodes a prediction function that is the input to the Learned Feature Combination module shown in FIG. 1.

It is understood that skilled artisans may implement a further extension to the system shown in FIG. 1 to employ one or more modules for enabling I/O communication between a user or computer system and the system 10 using, but not limited to, text, audio, video, gesture, tactile input and output etc. Thus, in one embodiment, both an input query and a generated query response may be provided one or more of multiple modalities including text, audio, image, video, tactile or gesture. If a question is posed using other modalities, e.g. a series of images pointed to by the user, the architecture of FIG. 1 may use the textual aspects of the images, captured in their descriptions or inferred by an analysis system (not shown).

An output 29 of the Question/Query analysis block 20 comprises a query analysis result data structure (CAS structure). In this embodiment, an output data structure Question/Query analysis module 20 and candidate answer generation module 30 may be implemented to pass the data among the modules, in accordance with the UIMA Open Source platform. The “Candidate Answer Generation” module 30 receives the CAS-type query results data structure 29 and generates a collection of candidate answers based on documents stored in Primary Sources 11 and in Answer Source KB 21. The “Candidate Answer Generation” module 30 includes, but is not limited to, one or more of the following functional sub-processing modules: A Term Weighting & Query Expansion module implementing functions for creating a query against modules 11 and 21 (part of query generation) with an embodiment implementing query expansion (see, e.g., http://en.wikipedia.org/wiki/Query_expansion); a Document Titles (Document Retrieval in Title Sources) module implementing functions for detecting a candidate answer (from sources 11 and 21); an Entities From Passage Retrieval module implementing functions for detecting a candidate answer in textual passages, e.g. based on grammatical and semantic structures of the passages and the query; and a KB Entities from Structured Sources module implementing functions for retrieving a candidate answer based on matches between the relations between the entities in the query and the entities in Answer Source KB 21, (implemented, e.g., as an SQL query).

As a result of implementing the functional modules of the Candidate Answer Generation block 30, a query is created and run against all of the structured and unstructured primary data sources 11 in the (local or distributed) sources database or like memory storage device(s). This query is run against the structured (KB), semi-structured (e.g., Wikipedia, IMDB databases, a collection of SEC filings in XBRL, etc.), or unstructured data (text repositories) to generate a candidate answer list 39 (also as a CAS, or an extension of prior CAS). In one embodiment, the query is run against a local copy of the listed primary source databases, or may access the publically available public database sources. Moreover, it should be understood that, in one embodiment, not all terms from the query need to be used for searching the answer—hence the need for creating the query based on results of the query analysis. For instance, in the phrase “five letter previous capital of Poland,” the term “five letter’ should not be part of the query. The Answer Source Knowledge Base 21 interfaces with the Entities from a Structured Sources module (not shown) that includes: Typed Lists (e.g., list of all countries in world), Precise Unary (e.g., a country), Binary (e.g., country+head of state of country), Ternary (e.g., country+head of state of country+wife of head of state), n-ary Relation Extracted, etc.

This processing depicted in FIG. 1, may be local, on a server, or server cluster, within an enterprise, or alternately, may be distributed with or integral with or otherwise operate in conjunction with a public or privately available search engine in order to enhance the question answer functionality in the manner as described. The Candidate Answer Generation module 30 may employ a search engine (a document retrieval system), which may be dedicated to the Internet, a publicly available database, a web-site (e.g., IMDB.com) or a privately available database. Databases can be stored in any storage system, e.g., a hard drive or flash memory, and can be distributed over a network or not.

As mentioned above, embodiments of the invention makes use of the Common Analysis System (CAS), a subsystem of the Unstructured Information Management Architecture (UIMA) that handles data exchanges between the various UIMA components, such as analysis engines and unstructured information management applications. CAS supports data modeling via a system independent of programming language, provides data access through a powerful indexing mechanism, and provides support for creating annotations on text data, such as described in (http://www.researchibm.com/journal/sj/433/gotz.html). The CAS also allows for multiple definitions of the linkage between a document and its annotations, as is useful for the analysis of images, video, or other non-textual modalities. The Common Analysis System (CAS) data structure form may be implemented as described in U.S. Pat. No. 7,139,752, the entire contents and disclosure of which is incorporated herein by reference.

In one embodiment, the UIMA may be provided as middleware for the effective management and interchange of unstructured information over a wide array of information sources. The architecture generally includes a search engine, data storage, analysis engines containing pipelined document annotators and various adapters. The UIMA system may be used to generate answers to input queries. The method includes inputting a document and operating at least one text analysis engine that comprises a plurality of coupled annotators for tokenizing document data and for identifying and annotating a particular type of semantic content. Thus it can be used to analyze a question and to extract entities as possible answers to a question from a collection of documents.

As shown in the architecture diagram of FIG. 1, the Query Analysis module 20 receives an input that comprises the query 19 entered, for example, by a user via their web-based browser device. An input query 19 may comprise a string such as “Who was the tallest American president?” Alternately, a question may consist of a string and an implicit context, e.g., “Who was the shortest?”. In this example, context may range from another siring e.g. “American presidents” or “Who was the tallest American president?” to any data structure, e.g. all intermediate results of processing of the previous strings—a situation arising e.g., in a multiple turn dialog. The Query Analysis module 20 includes one or more sub-processes such as A Parse and Predicate Argument Structure block (not shown) that implements functions and programming interfaces for decomposing an input query into its grammatical and semantic components, e.g., noun phrases, verb phrases and predicate/argument structure. An English Slot Grammar (ESG)-type parser may be used to implement parsing and a Focus Segment, Focus & Modifiers block may be provided that computes the focus and focus modifiers of the question. Other implementations may further include a Question decomposition block (not shown) in the query analysis module 20 that implements functions and programming interfaces for analyzing the input question to determine the sets of constraints specified by the question about the target answer. The query analysis block 20 includes a Lexical Answer Type (LAT) block 200 that implements functions and programming interfaces to provide additional constraints on the answer type.

In FIG. 1, the LAT block 200 includes certain functions/sub-functions (not shown) to determine LATs. These sub-functions, in one embodiment, include a parser such as the ESG parser as described above, and a co-reference resolution module (as described e.g. in http://www.isi.edu/˜hobbs/muc5-generic-final.pdfi and http://gate.ac.uk/sale/taln02/taln-ws-coref.pdf). The certain functions/sub-functions operate to compute an LAT from a natural language analysis of the query and provide more of a description of an answer than its ontological category. Thus, for example, the italicized words in the following sentence represent the LAT “After circumnavigating the Earth, which explorer became mayor of Plymouth, England?” The answer must include both “explorer” and “mayor,” and these two strings become the question's LATS. In practice, a LAT is a descriptor of the answer detected by a natural language understanding module comprising a collection of patterns or a parser with a semantic interpreter. It is understood that additional functional blocks may be include in the Query Analysis module 20. These additional modules may include, for instance, a Lexical and Semantic Relations module to detect lexical and semantic relations in the query a Question Classification block that may employ topic classifiers providing information addressing, and a Question Difficulty module for executing methods providing a way to ascertain a question's difficulty.

The Lexical Answer Type (LAT) block 200, in the query analysis module 20, represents the question terms that identify the semantic type of the correct answer. As is known, an LAT may be detected in a question through pattern rules such as “any noun phrase that follows the wh-word and serves as the subject or the object of the main verb in a question is a LAT”. For example, in the question “Which Dublin-born actor once married Ellen Barkin?”, the noun phrase “Dublin-born actor” follows the wh-word “which”, and is the subject of the main verb “marry”. LAT detection rules can be encoded manually or learned by machine automatically through association rule learning. In this case, the natural language understanding module can be limited to implementation of simple rules as described above. LATs should include modifiers of the main noun if they change its meaning. For example, a phrase “body of water” has different meaning than “water” or “body”, and therefore in the query: “Joliet and Co found that the Mississippi emptied into what body of water?”, the LAT includes the whole phrase “body of water.”

Multiple LATs can be present in the query and the context, and can even be present in the same clause. For example, in the following query: “In 1581, a year after circumnavigating the Earth, which explorer became mayor of Plymouth, England?”, the LATs are “explorer” and “mayor.” Similarly, in the query: “Which New York City river is actually a tidal strait connecting upper New York Bay with Long Island Sound?”, the LATs are “river” and “strait.”

In many cases, the LATs of the question can be computed using simple rules, as described above. In other situations, such as when multiple LATs are present, the LATs may be computed based on grammatical and predicate argument structure. Thus, the natural language understanding module may include a parser (such as ESG) to compute the grammatical structures, and a shallow semantic interpreter to compute the semantic coreference between the discourse entities, such as “river” and “tidal strait” or “explorer” and “mayor” and to add both of them to the list of LATs. Also, the LATs can include modifiers. Thus, in the first example discussed above, the list of LATs may include [explorer, mayor, mayor of Plymouth, mayor of Plymouth, England]. A minimal possible noun phrase that identifies the answer type corresponds to the maximal entity set, and the maximal noun phrase provides the best match.

An LAT is not an ontological type but a marker. Semantically, an LAT is a unary predicate that the answer needs to satisfy. Since multiple LATs are the norm, and matches between candidate LATs and query LATs are usually partial, a scoring metric is often used, where the match on the LATs with modifiers is preferred to the match on simple head noun.

A number of procedures are known for determining LAT; and for example, U.S. patent application Ser. No. 12/126,642 describes a procedure for obtaining the LAT from the original question. The present invention provides an alternative to extracting an LAT from the original question and may be particularly useful in cases where no LAT is present in the clue.

As mentioned above, for some questions, some plausible lexical types of a question are implicit in the text of the question. Consider the example “What flew from New York to Paris in May of 1927?” There is no explicit LAT in the question. However some potential LATs can be inferred by trying to consider things that fly: airplanes, birds, etc. This information can be derived from a large text corpus by, for example, searching for “fly,” determining what strings precede it, and counting the occurrences of different terms such as “airplane”, ‘bird’, etc. Confidence values can be produced for the entries in this list using the frequency of occurrences. An n-gram corpus is a particularly useful resource for enabling such a search, because frequency data for snippets of text are precompiled in that resource. A keyword search index is an alternative component that satisfies this requirement (but requires that the invoking process count all of the occurrences instead of combining counts that are precomputed).

The list can be further refined by examining larger quantities of context. For example, a search can be conducted to try to find things that fly from New York, or things that fly to Paris, things that fly in May of 1927, etc. A type hierarchy can also be used to identify more abstract variations of the context, e.g., things that fly from specified cities, things that fly on specified dates. By combining statistics from different amounts of context, better confidence values can potentially be produced. These confidence values can be used by an end-to-end QA system to produce more informative scores.

The inferred LATs and their confidence values can be used by the remaining portions of the deferred type evaluation process, such as disclosed in U.S. patent application Ser. No. 12/126,642 to identify candidate answers to the question that are of the appropriate type, so that those candidate answers can be preferred over candidate answers that are not of the appropriate type.

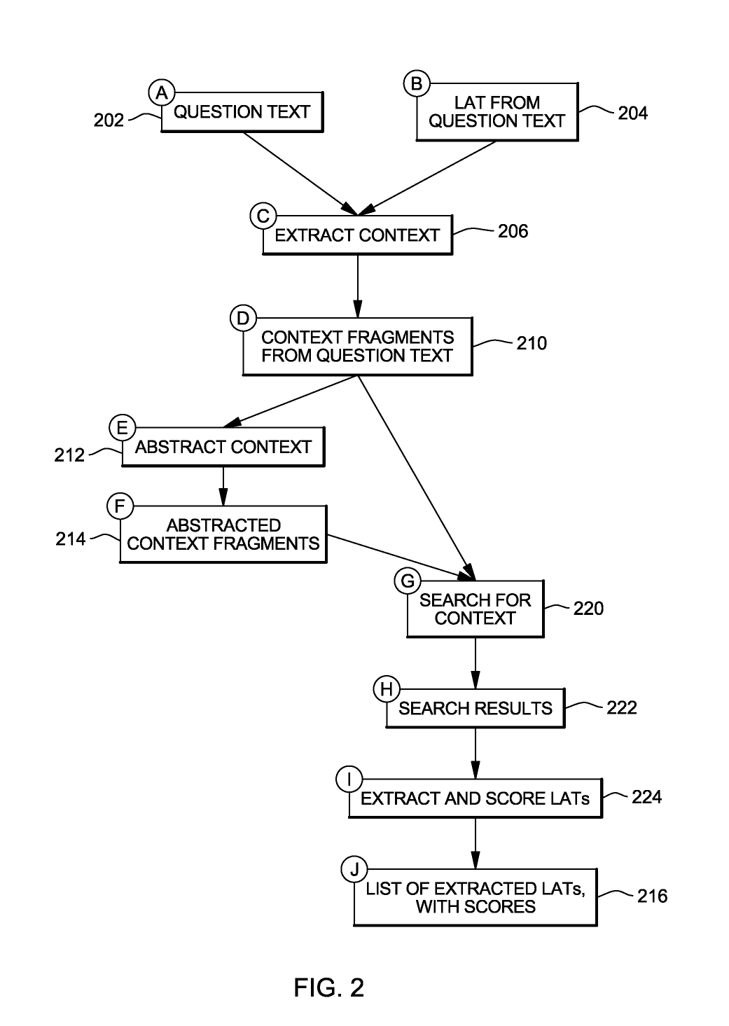

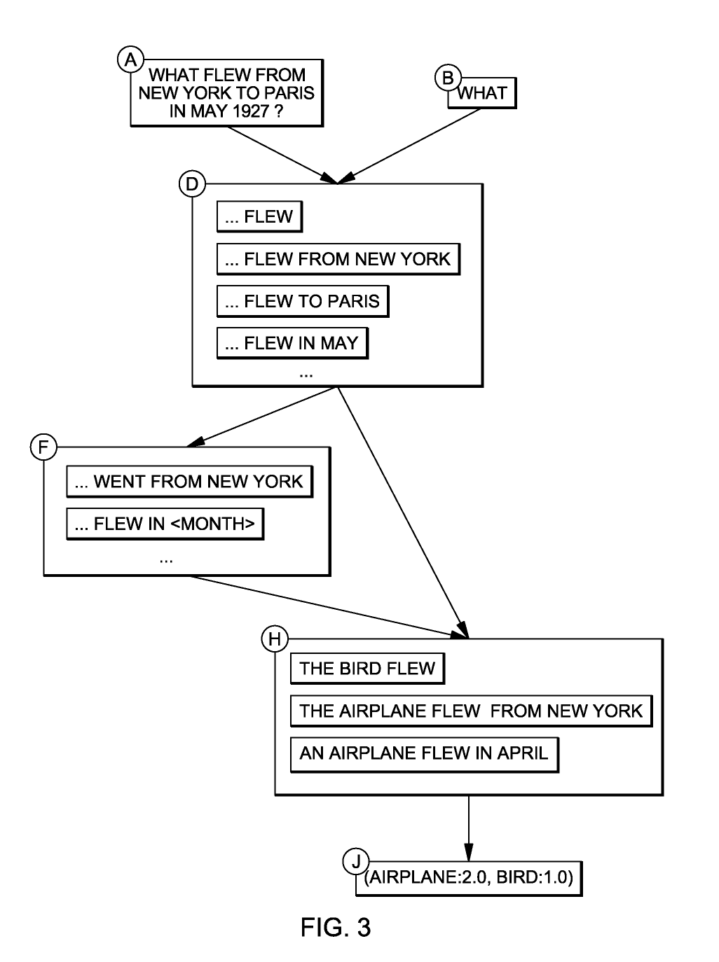

FIG. 2 shows the data and procedural elements of an embodiment of the invention. FIG. 3 shows a specific example of the data elements.

With reference to FIG. 2, inputs to the system and method are a textual question (202), which is usually provided by a user, and a LAT from the question (204), which may be computed via the process depicted in U.S. patent application Ser. No. 12/126,642. Given these inputs, the context 206 is extracted in which the LAT occurs within the question. This extraction results in a set of context fragments 210 from the question text. Context fragments may include words that are directly or indirectly connected to the LAT in the question.

Connectedness may be determined by lexical ordering (e.g., the next one or more words after the LAT can be considered a context) and/or by grammatical and/or semantic relationships that may have been identified during question analysis. For example, in the above-discussed example question “What flew from New York to Paris in May of 1927?” the prepositional phase “to Paris” directly modifies “flew,” so the context “flew to Paris” encodes a coherent subgraph of the parse even though the words in it are not connected via lexical ordering.

The context fragments are sent to a component that produces more abstract versions 212, 214 of the context fragments (E and F). One way to produce more abstract versions of a context is to replace a word in the context with another word that is more general than the original word. For example, the verb “fly” is a more specific form of the word “go,” so a context fragment like flew from New York” can be abstracted into a context fragment like “ . . . went from New York”. One way to obtain a generalization of a word is from a lexical resource such as WordNet, which has that information. Another way to produce a more abstract version of a context is to replace a word with some term in a structured ontology. For example, “ . . . flew in May” may be replaced with a partially structured context fragment “ . . . flew in <month>”.

The original and abstracted context fragments are all provided as input to a search component 220. If the implementation of the abstraction module produces partially structured context fragments (as in the “ . . . flew in <month>”) example, then the search component needs to be able to process partially structured search queries; that capability is referred to as “semantic search” and is an established technology. Alternatively, if the abstraction module outputs only context fragments composed of words (as in the “ . . . went from New York” example), then the search can be conducted using simple keyword matching. An n-gram corpus is a particularly useful resource for doing this keyword matching because it provides counts associated with each matching string. The output of the search process is a set of search results 222 which include the text found and optionally a count of how frequent that text occurs.

The search results are sent to a process 224 that extracts LATs from those results. The resulting extracted LATs are also assigned scores 226. The LATs are identified by aligning the original context fragment to the found text and extracting the term in the found text that corresponds with the LAT in the original context fragment. For example, if the context fragment “ . . . flew” is aligned with the text “the bird flew,” then the new extracted LAT will be “the bird” or “bird.” Extracted LATs may be scored using a variety of formulas. One way to score extracted LATs is to count the number of text fragments in which they occur. This technique is used in FIG. 3, assigning a score of 2.0 to the LAT “airplane” because it can be extracted from two of the search results in that figure, while the LAT “bird” is only given a score of 1.0 because it appears only once. If the search results include counts for the texts found (e.g., because they came from an n-gram corpus, as discussed above), then the scoring function may sum those counts to produce a total count.

More advanced scoring techniques for extracted LATs can use other information besides counts. The magnitude or frequency (in a corpus) of the context fragment may be useful; for example, matches for “ . . . flew from New York” may be more informative than matches for “., flew”. In addition, the degree of abstraction (if any) may be also be useful in scoring. For example, matches for “ . . . flew” may be more informative than “ . . . went”.

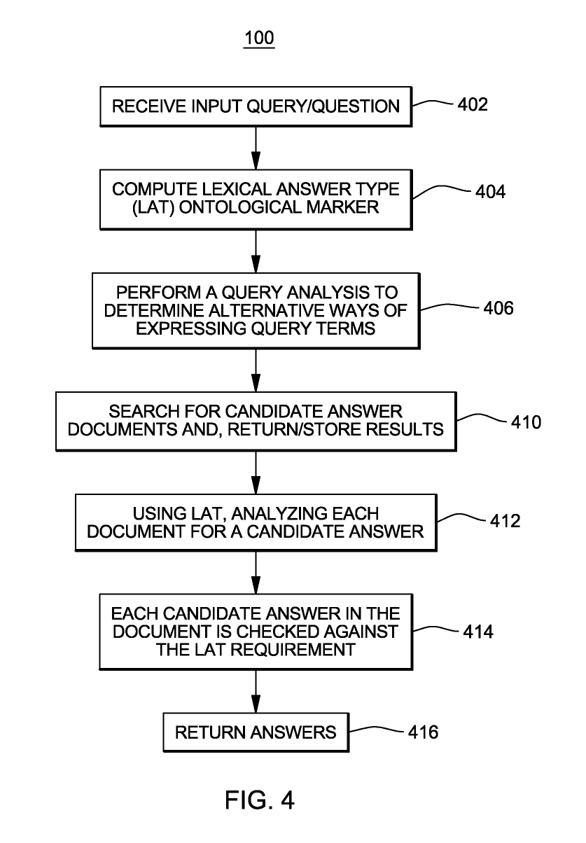

A method of deferred type evaluation, in which the invention may be used, is illustrated in the flow chart as depicted in FIG. 4. In this method, step 402 represents receiving an input query, and generating a data structure, e.g., a CAS structure, including a question string and context for input to the Lexical Answer Type (LAT) block 200 of FIG. 1. In this LAT block, at step 404, the Query is analyzed and lexical answer type (LAT) is computed. As an example, an input query, maybe:

“which 19th century US presidents were assassinated?”
would compute an LAT as “19th century US president” (but also as “US president” and “president”).

As a result of processing in the LAT block 200, as typified at step 115, there is generated an output data structure, e.g., a CAS structure is generated, including the computed LAT and additional terms from the original question. Alternately, or in addition, as represented at step 406 of FIG. 4, the functional modules of the query analysis block 20 may produce alternative ways of expressing terms. For example, an alternative way, or a pattern, of expressing “19th century”, e.g., will include looking for a string “18\d\d” (where \d stands for a digit, “XIXth ce.” etc. Thus, the query analysis block may investigate the presence of synonyms in the query analysis.

At processing step 410, a search is performed for candidate answer documents, and the results are returned and stored. Thus, for the example query described above (“which 19th century US presidents were assassinated?”), the following documents including candidate answer results may be returned, http://en.wikipedia.org/wikilList_of_United_States_Presidential_assassination_attempts, http://www.museumspot.com/know/assassination.htm, http://www.presidentsusa.net/presvplist.html

As a result of processing in the candidate answer generation module 30, at step 122, an output data structure 39 is generated, e.g., a CAS structure, including all of the documents found from the data corpus (e.g., primary sources and knowledge base). At step 412, each document is analyzed for a candidate answer to produce a set of candidate answers which may be output as a CAS structure using LAT. For the example questions discussed herein, as a result of processing in the candidate answer generation module 30, at step 414, those candidate answers that are found will be returned as answer(s): e.g., Abraham Lincoln, James A. Garfield.

Step 414 implements the following: (a) for each candidate answer received, matching the candidate against instances in the database, which results in generating an output data structure, e.g., a CAS structure, including the matched instances; (b) retrieving types associated with those instances in the knowledge base (KB), and (c) attempting to match LAT(s) with types, producing a score representing the degree of match. Procedures for implementing these functions are described in U.S. patent application Ser. No. 12/126,642. At step 416 the top Candidate Answers are returned.

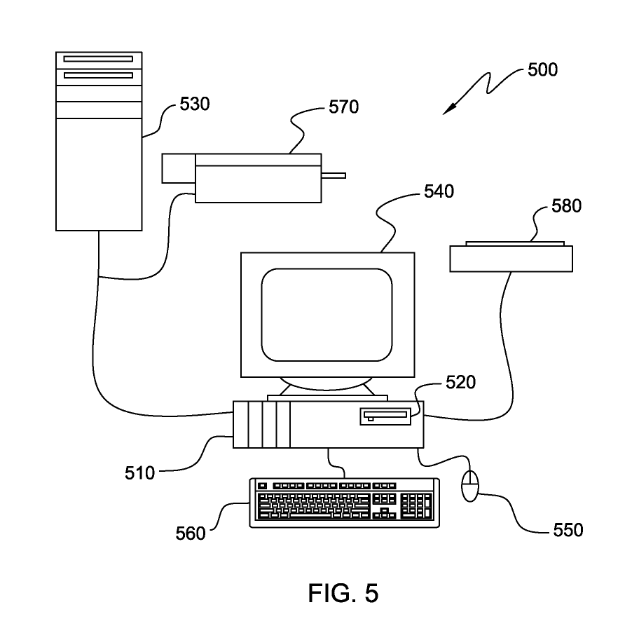

A computer-based system 500 in which a method embodiment of the invention may be carried out is depicted in FIG. 5. The computer-based system 500 includes a processing unit 510, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 510 through a disc drive 520, or by any means known to the skilled artisan for providing the computer program product to the general purpose processing system for operation thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 510, as mentioned, or may be located on a remote system such as a server 530, coupled to processing unit 510, via a network interface such as an Ethernet interface. Monitor 540, mouse 550 and keyboard 560 are coupled to the processing unit 510, to provide user interaction. Scanner 580 and printer 570 are provided for document input and output. Printer 570 is shown coupled to the processing unit 510 via a network connection, but may be coupled directly to the processing unit. Scanner 580 is shown coupled to the processing unit 510 directly, but it should be understood that peripherals might be network coupled, or direct coupled without affecting the ability of the processing unit 110 to perform the method of the invention.

While it is apparent that the invention herein disclosed is well calculated to fulfill the objects stated above, it will be appreciated that numerous modifications and embodiments may be devised by those skilled n the art, and it is intended that the appended claims cover all such modifications and embodiments as fall within the true spirit and scope of the present invention.

1. A method of searching for an inferred lexical answer type from the context of a question, comprising:
receiving a question;
determining from the question an original lexical answer type (LAT);
extracting the context in which said original LAT occurs within the question;
identifying a set of context fragments from said context;
using the set of context fragments in a given procedure for searching through a defined database to produce a search result including a plurality of text strings having a specified relationship with said context fragments; and
processing said search result to search for one or more inferred LAT of the question.

2. The method according to claim 1, wherein the processing includes:
extracting a plurality of LATs from the text strings in the search results; and
selecting one or more of the extracted LATs.

3. The method according to claim 2, wherein the selecting includes:
ranking said extracted LATs according to a given criteria; and
selecting said one of the extracted LATs on the basis of said ranking.

4. The method according to claim 3, wherein said ranking is based on the frequency with which each of the extracted LATs occurs in said plurality of text strings.

5. The method according to claim 2, wherein the extracting a plurality of LATs from the text strings includes, for each of the plurality of text strings:
aligning one of the context fragments including the original LAT with said each of the text strings; and
extracting the term in said each of the text strings that corresponds with the original LAT in said one of the context fragments.

6. The method according to claim 1, wherein the using the set of context fragments in the given procedure includes:
producing abstract versions of the context fragments;
inputting the context fragments and the abstract versions of the context fragments to a search component;
said search component searching through the defined database for text strings that match either the context fragments or the abstract versions of the context fragments according to defined criteria.

7. The method according to claim 6, wherein the producing abstract versions of the context fragments includes replacing selected words in the context fragments with other words that are more general than said selected words.

8. The method according to claim 6, wherein the producing abstract versions of the context fragments includes replacing selected words in the context fragments with terms in structured ontologies.

9. The method according to claim 1, wherein the context fragments are determined by lexical ordering.

10. The method according to claim 1, wherein the context fragments are determined by semantic relationships.

11. A system for searching for an inferred lexical answer type from the context of a question, the system comprising one or more processing units configured for:
receiving a question;
determining from the question an original lexical answer type (LAT);
extracting the context in which said original LAT occurs within the question;
identifying a set of context fragments from said context;
using the set of context fragments in a given procedure for searching through a defined database to produce a search result including a plurality of text strings having a specified relationship with said context fragments; and
processing said search result to search for one or more inferred LAT of the question.

12. The system according to claim 11, wherein the processing includes:
extracting a plurality of LATs from the text strings in the search results; and
selecting one or more of the extracted LATs.

13. The system according to claim 12, wherein the selecting one of the extracted LATs includes:
ranking said extracted LATs according to a given criteria; and
selecting said one of the extracted LATs on the basis of said ranking; and wherein said ranking is based on the frequency with which each of the extracted LATs occurs in said plurality of text strings.

14. The system according to claim 12, wherein the extracting a plurality of LATs from the text strings includes, for each of the plurality of text strings:
aligning one of the context fragments including the original LAT with said each of the text strings; and
extracting the term in said each of the text strings that corresponds with the original LAT in said one of the context fragments.

15. The system according to claim 11, wherein the using the set of context fragments in the given procedure includes:
producing abstract versions of the context fragments;
inputting the context fragments and the abstract versions of the context fragments to a search component;
said search component searching through the defined database for text strings that match either the context fragments or the abstract versions of the context fragments according to defined criteria.

16. An article of manufacture comprising:
at least one computer usable medium having computer readable program code logic to execute instructions in a processing unit for searching for an inferred lexical answer type from the context of a question, said computer readable program code logic, when executing, performing the following:
receiving a question;
determining from the question an original lexical answer type (LAT);
extracting the context in which said original LAT occurs within the question;
identifying a set of context fragments from said context;
using the set of context fragments in a given procedure for searching through a defined database to produce a search result including a plurality of text strings having a specified relationship with said context fragments; and
processing said search result to search for one or more inferred LAT of the question.

17. The article of manufacture according to claim 16, wherein the processing includes:
extracting a plurality of LATs from the text strings in the search results; and
selecting one or more of the extracted LATs.

18. The article of manufacture according to claim 17, wherein the selecting one of the extracted LATs includes:
ranking said extracted LATs according to a given criteria; and
selecting said one of the extracted LATs on the basis of said ranking; and wherein:
said ranking is based on the frequency with which each of the extracted LATs occurs in said plurality of text strings.

19. The article of manufacture according to claim 17, wherein the extracting a plurality of LATs from the text strings includes, for each of the plurality of text strings:
aligning one of the context fragments including the original LAT with said each of the text strings; and
extracting the term in said each of the text strings that corresponds with the original LAT in said one of the context fragments.

20. The article of manufacture according to claim 16, wherein the using the set of context fragments in the given procedure includes:
producing abstract versions of the context fragments;
inputting the context fragments and the abstract versions of the context fragments to a search component;
said search component searching through the defined database for text strings that match either the context fragments or the abstract versions of the context fragments according to defined criteria.
